(19) United States
(12) Patent Application Publication
(10) Pub. No.: US 2014/0327516 A1
(43) Pub. Date: Nov. 6, 2014

(54) METHOD, SYSTEM, AND KIT FOR MAKING AN ASSET MONITORABLE BY A SECURITY ASSET MANAGEMENT SYSTEM

(71) Applicant: Key Systems, Inc., Fishers, NY (US)

(72) Inventor: George H. Eckerdt, Victor, NY (US)

(21) Appl. No.: 14/266,221

(22) Filed: Apr. 30, 2014

Related U.S. Application Data
(60) Provisional application No. 61/818,117, filed on May 1, 2013.

(51) Int. Cl. G07C 9/00

(52) U.S. Cl. CPC G07C 9/00007
USPC 340/5.6

(57) ABSTRACT

An identification insert includes identification circuitry on a support layer and connected to a plug receptacle placing the circuitry in communication with another device when a plug of the device is inserted into the receptacle. A cavity in an asset, such as a firearm, can house the identification insert to enable a security asset management system or other device to monitor the presence or absence of the asset. A housing can carry the insert such that when the housing is inserted in the cavity the plug receptacle is accessible and substantially flush with an external surface of the asset.

### FIELD

The claimed invention generally relates to methods and systems for security asset management.

### BACKGROUND

There is a need to store and track valuable assets, such as, but not limited to firearms. It is desirable to have a system and method to monitor access to those assets, such that certain assets are automatically logged out to authorized users when taken, following presentation of accepted identification. Furthermore, there is a need for the system to be able to recognize when a particular asset has been returned.

### BRIEF DESCRIPTION OF THE DRAWINGS

FIG. 1 schematically illustrates one embodiment of a security asset management system.

FIG. 2 schematically illustrates another embodiment of a security asset management system.

FIG. 3 illustrates one embodiment of an identification insert for attaching identification circuitry to an asset.

FIG. 4 illustrates one embodiment of identification circuitry housed within an embodiment of a firearm insert.

FIG. 5A illustrates the embodied firearm insert of FIG. 4 next to a portion of a firearm grip.

FIG. 5B illustrates the embodied firearm insert of FIG. 4 inserted into a firearm grip.

FIG. 6 schematically illustrates another embodiment of a security asset management system.

FIG. 7 illustrates one embodiment of a rifle stock, in partial cross-sectional view, showing one embodiment of identification circuitry coupled to the stock.

FIGS. 8A to 8D-2 illustrate two embodiments of a method for installing identification circuitry in an asset to make it monitorable by a security asset management system.

FIG. 9 illustrates one embodiment of an insert alignment tool for use when installing identification circuitry in an asset.

FIGS. 10A-10E illustrate two further embodiments of a method for installing identification circuitry in an asset to make it monitorable by a security asset management system.

FIG. 11 illustrates another embodiment of an insert alignment tool for use when installing identification circuitry in an asset.

FIGS. 12A-12E illustrate two more embodiments of a method for installing identification circuitry in an asset to make it monitorable by a security asset management system.

FIGS. 13-14B schematically illustrate embodiments of a kit for retrofitting an asset to make it monitorable by a security asset management system.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

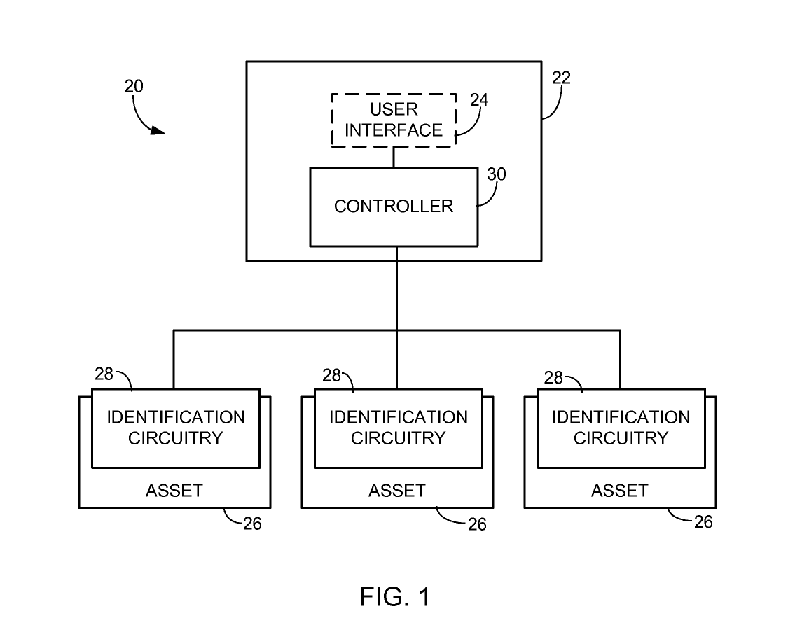

FIG. 1 illustrates one embodiment of a security asset management system 20. The system 20 includes a security asset manager (SAM) 22. Depending on the embodiment, the SAM 22 may have a user interface 24, comprising one or more of a variety of user identification (ID) devices, such as a keypad for personal identification number (PIN) entry, a fingerprint reader, and a proximity card reader. Those skilled in the art will understand that other types of user ID devices may be used, such as, but not limited to an iris ID device, a retinal scanning ID device, a hand shape ID device, and a magnetic card reader. The SAM 22 may also control one or more locked doors and/or lockers (not shown) which may be unlocked by the SAM 22 following the user identification.

In this embodiment, behind the one or more doors, authorized users will be able to reach one or more assets 26. Assets may include, but are not limited to, firearms and tasers. Some non-limiting examples of firearms include hand guns, shot guns, and rifles. Each of the assets 26 has its own identification circuitry 28 which is configured to have a unique electronic identifier which may be associated with its corresponding asset 26. One suitable non-limiting example of identification circuitry is the DS2401P+ touch memory device from Maxim Integrated.

The SAM 22 has a controller 30 in communication with or coupled to the user interface 24. The controller 30 may also be removably coupled to or placed in communication with the one or more assets 26 via their identification circuitry 28. The controller 30 may include, but is not limited to, a computer, a microprocessor, an application specific integrated circuit (ASIC), a field programmable gate array (FPGA), digital circuitry, analog circuitry, or any combination and/or plurality thereof, or any suitable computing device, whether local or distributed. In embodiments, controller 30 can include or be in communication with a non-transitory computer readable storage medium having computer-readable instruction stored thereon in the form of executable code that when executed by controller 30 causes or enables controller 30 to perform the various actions or functions described herein, as well as other actions or functions as may be suitable and/or desired. The controller 30 may communicate with an asset's identification circuitry 28, when it is coupled, using a suitable electronic communication scheme, such as, but not limited the One Wire Communication Bus designed by Dallas Semiconductor Corp. The controller 30 can detect when an asset 26 has been plugged in or removed from the bus, and since only known authorized users are given access to the SAM 22, the controller 30 can monitor what assets are present, who has taken removed assets, and who has returned them.

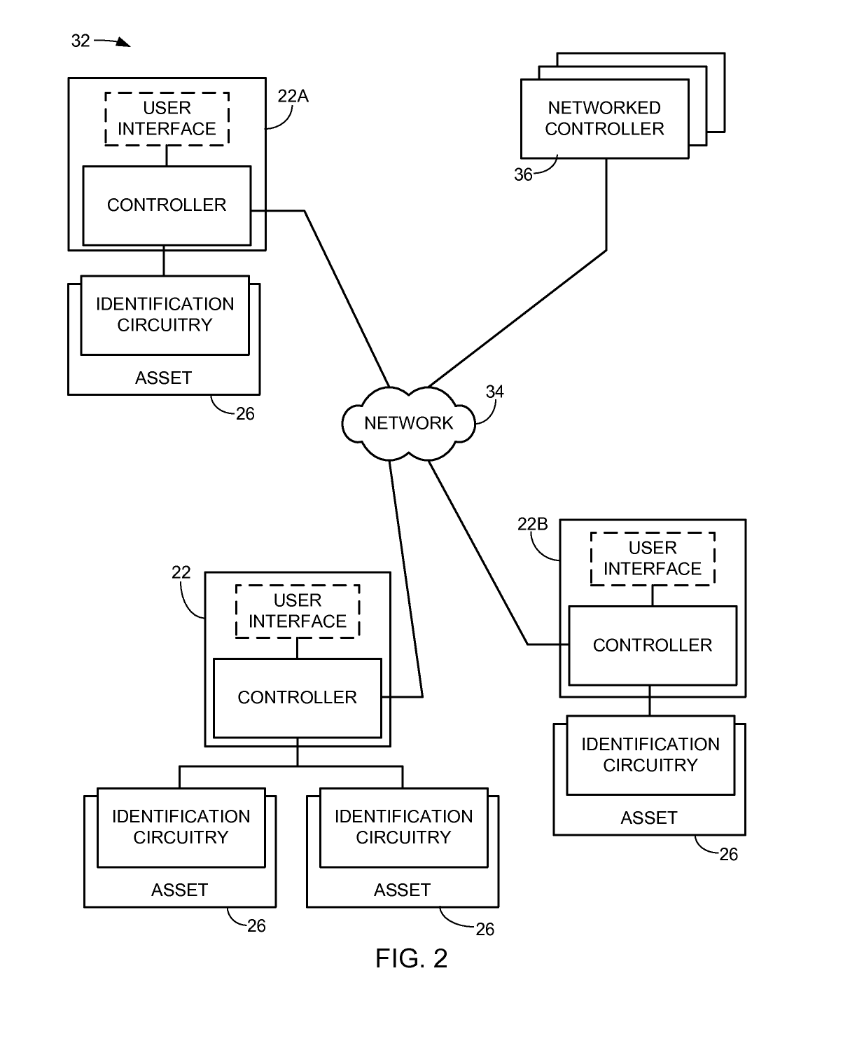

FIG. 2 schematically illustrates another embodiment of a security asset management system 32. This embodiment includes a security asset manager (SAM) 22, the features of which have been discussed above. The SAM 22 may be coupled to and/or in communication with one or more other SAMs 22A, 22B via a network 34. One or more networked controllers 36 may also be coupled to one or more SAMs via the network 34. The network 34 may be, but is not limited to, a local area network (LAN), a wide area network (WAN), a wireless LAN, a wireless WAN, or any combination and/or plurality thereof. In some embodiments, one of the networked controllers 36 may be a server running asset management software for coordinating and collecting data from one or more SAMs 22, as well as providing reports on authorized user activity, asset status, and alarms. One suitable example of asset management software is the Global Facilities Management System software available from Key Systems, Inc. In other embodiments, another of the networked controllers 36 may include, but is not limited to, a computer, a laptop, a smartphone, and/or a cellular phone which is able to interact via a browser or other web enabled client with either a remote server running asset management software or an embedded web server in one of the SAMs 22.

In a networked system, such as illustrated in FIG. 2, an asset 26 may be removed from and returned to any SAM 22, and the controllers in each SAM can communicate the asset status to other controllers either directly or via a coordinating asset management software.

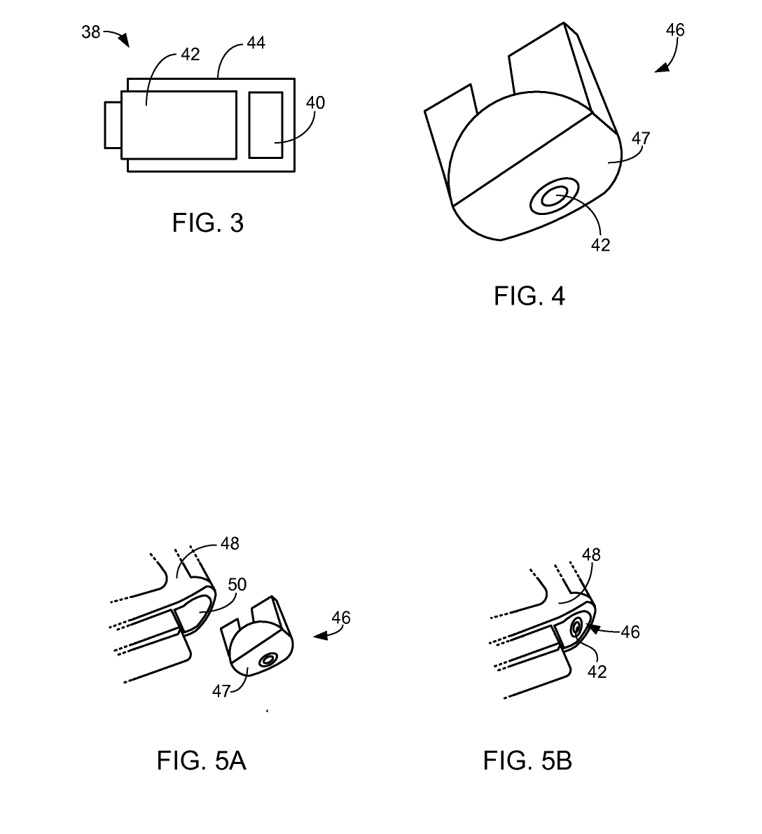

In order to track assets in security asset management systems, such as, but not limited to those discussed above, it is useful to have a way to attach identification circuitry to an asset in a manner that enables the identification circuitry to stay with the asset while allowing the attached circuitry to be removably coupled to the controller. FIG. 3 illustrates one embodiment of an identification insert 38 for attaching identification circuitry 40 to an asset. An electronic plug receptacle 42 is coupled to the identification circuitry 40, and configured to communicate one or more electrical connections (for example, a 1-wire data signal and a ground connection) to the identification circuitry when a mating plug is plugged into the plug receptacle 42. The electrical connections between the plug receptacle 42 and the identification circuitry 40 may be provided by a circuit board 44, which can also provide physical support and can thus also be called a support layer. In embodiments where at least a portion of a touch memory device, such as an identification chip or module or device, is used as the identification circuitry 40, the plug receptacle 42 would normally need to provide two connections to the identification circuitry 40, one for a shared power supply/data signal and another for a ground connection.

FIG. 4 illustrates one embodiment of identification circuitry housed within an embodiment of a firearm insert 46. In this embodiment, the identification circuitry is not visible from this view, but the end of the plug receptacle 42 can be seen, accessible through a housing 47 of the firearm insert and substantially flush with an external surface of housing 47. FIG. 5A illustrates the embodied firearm insert 46 next to a portion of a firearm grip 48. Housing 47 of firearm insert 46 may be sized to fit into or be formed to correspond to a cavity in a firearm, such as cavity 50, such that an external surface of housing 47 is substantially flush with an external surface of the firearm, and so that the end of plug receptacle 42 is also substantially flush with an external surface of the firearm. In embodiments, cavity 50 can be a pre-existing cavity, while in other embodiments, the cavity can be formed specifically for firearm insert 46. FIG. 5B illustrates the embodied firearm insert 46 inserted into the firearm grip 48. The electronic plug receptacle 42 is readily available for coupling to a security asset manager (SAM) as described above.

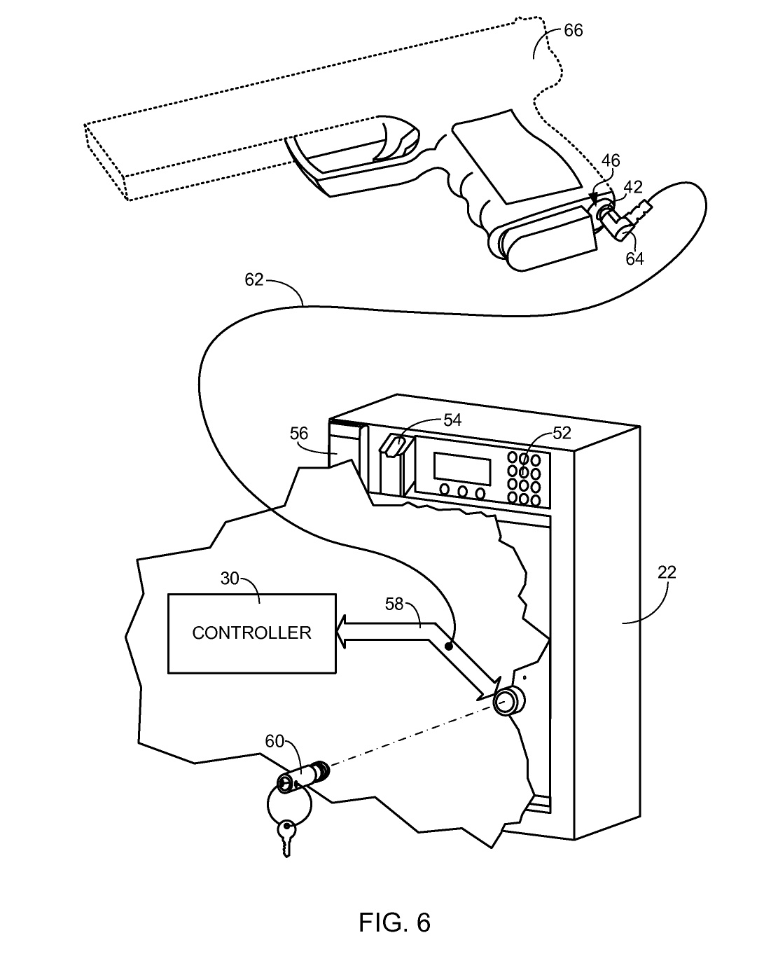

As one example, FIG. 6 schematically illustrates another embodiment of a security asset management system in a partially exploded view. As described above, the security asset management system includes a SAM 22 having a controller 30 coupled to a user interface, such as, but not limited to a keypad 52, a fingerprint reader 54, and/or a proximity card reader 56. The controller 30 may be coupled to a communication bus 58, such as, but not limited to a Dallas Semiconductor 1-wire communication bus. A variety of devices may be coupled to the communication bus 58, for example, a key fob 60 having identification circuitry which plugs directly into the SAM 22. Although not shown, some SAMs may also control one or more solenoids to enable directly controllable key entrapment and/or other latched asset control. One or more cables 62, coupled on one end to the communication bus 58, may be provided with a plug 64 for coupling to assets with identification inserts that include identification circuitry. In this example, firearm 66 has such an identification insert 46 as described previously. The identification circuitry (not visible in this view, but discussed above) of firearm 66, is coupled to the controller 30 via plug receptacle 42, plug 64, cable 62, and communication bus 58. The controller 30 will sense and/or receive the unique electronic identifier from the identification circuitry and will know the firearm 66 (asset) is present. The SAM 22 can be set up so that only authorized persons, identified to the system through the user interface (for example by PIN entry, finger print scan, or presentation of an access card), can remove the asset 66. In order to remove the asset 66, the plug 64 will need to be disconnected from the plug receptacle 42. Upon disconnection of the plug 64 from the plug receptacle 42, the unique identifier (from the identification circuitry) associated with the asset 66 will no longer be visible to the controller 30. In this case, the controller 30 will know the asset 66 has been disconnected and the asset 66 can automatically be logged as out with the authorized user who had access at the time of removal. Similarly, when the asset 66 is returned and plugged back in, the unique identifier associated with the asset will become visible to the controller again. Thus, the controller 40 will know the asset has been attached and the asset can automatically be logged as having been returned by the authorized user who had access at the time of return. If an asset is removed by an unauthorized user, then an alarm can be set by the SAM 22.

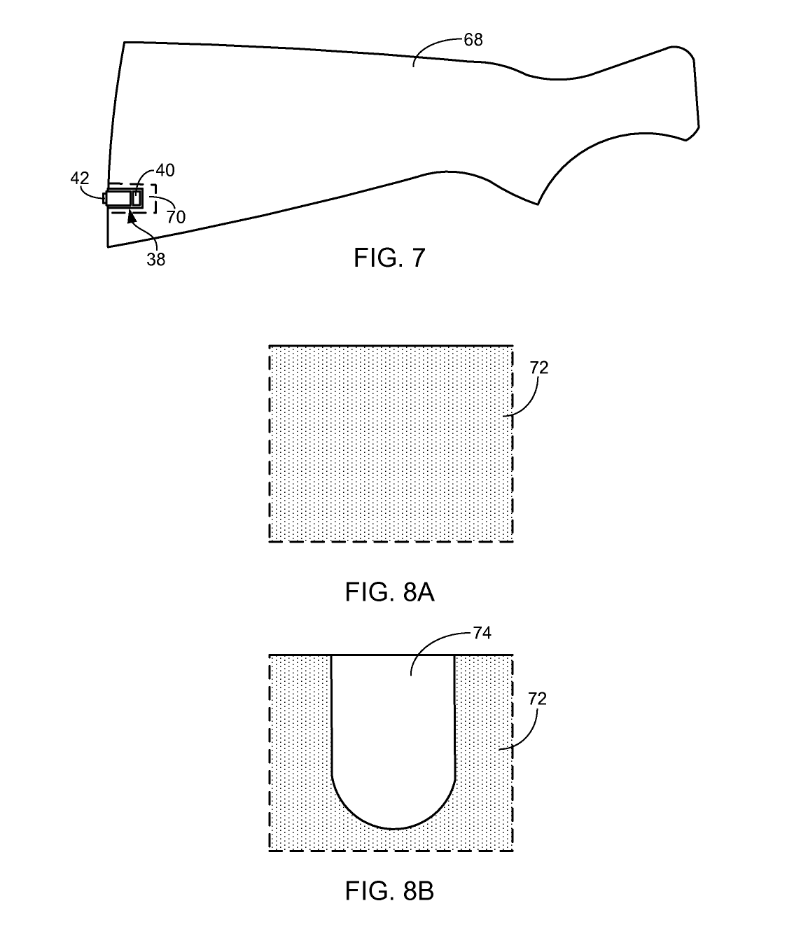

While it is perhaps more convenient if an identification insert has a special housing to mate with a cavity and/or feature of an asset, such as the firearm insert 46 of FIGS. 4-5B (discussed previously), it is alternately possible to attach an identification insert into an asset using an insert embodiment 38 (also discussed previously), such as the insert illustrated in FIG. 3. FIG. 7 illustrates one embodiment of a rifle stock 68, in partial cross-sectional view, showing one embodiment of identification circuitry 40 coupled to the stock. The identification circuitry 40 is supported by a circuit board as part of an identification insert 38 having an electronic plug receptacle 42 such that the end of plug receptacle 42 is substantially flush with an external surface of rifle stock 68 or other firearm in which it is mounted. The insert may be mounted into a cavity 70 formed in the rifle stock 68. Although the insert 38 was illustrated as being installed in a rifle stock, it may be installed in a variety of items, provided a cavity, large enough to house at least a portion of the insert 38, may be formed or already exists in the items.

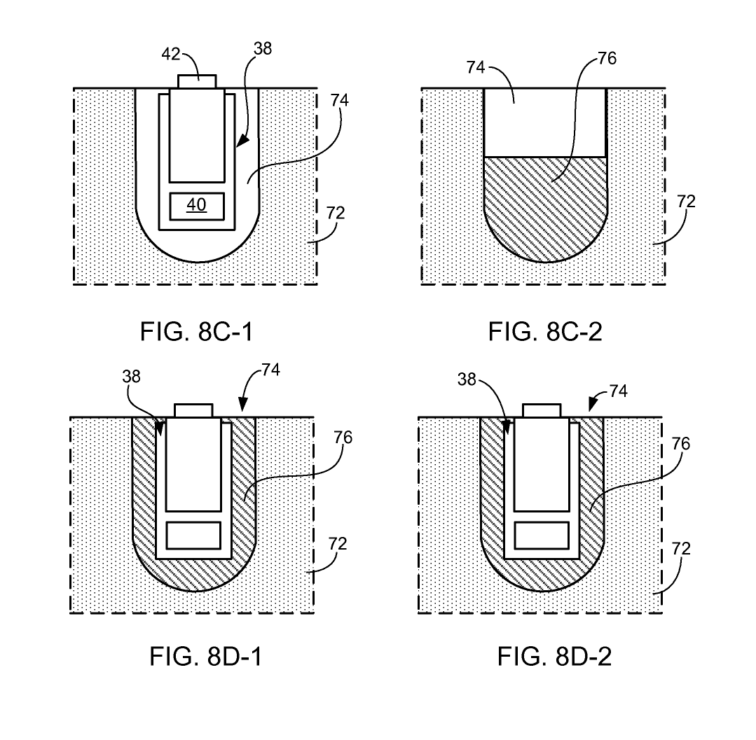

FIGS. 8A-8D-2 illustrate two embodiments of a method for installing identification circuitry in an asset to make it monitorable by a security asset management system. FIG. 8A illustrates a portion of an asset 72 into which it is desired to install identification circuitry. As illustrated in FIG. 8B, a cavity 74 may be formed in the asset 72. The cavity 74 can be formed in a variety of materials, including, but not limited to wood, metal, and plastic. The cavity 74 should be large enough to allow a desired portion of an identification insert to fit therein. In some embodiments, a suitable cavity 74 may already exist in the asset 72. As illustrated in FIG. 8C-1, an identification insert 38, having identification circuitry 40, is placed into the cavity 74 of the asset 72. In this example, it is desired to have all of the identification insert 38, except the tip of the electronic plug receptacle 42 fit within the cavity 74. In the step shown in FIG. 8D-1, the remaining cavity 74 around the identification insert 38 is filled with filler 76, such as, but not limited to an epoxy or electronic grade silicon rubber. As just one example, a five-minute epoxy from Loctite, UPC #079340686175 may be used. When the filler 76 has cured, the asset is ready for use with a security asset management system as described above.

In an alternate embodiment, instead of the actions illustrated in FIGS. 8C-1 and 8D-1, the cavity 74 may be at least partially filled with a filler 76 as shown in FIG. 8C-2. The identification insert 38 may then be placed into the cavity 74, before the filler 76 cures, as shown in FIG. 8D-2. Again, when the filler 76 has cured, the asset is ready for use with a security asset management system as described above.

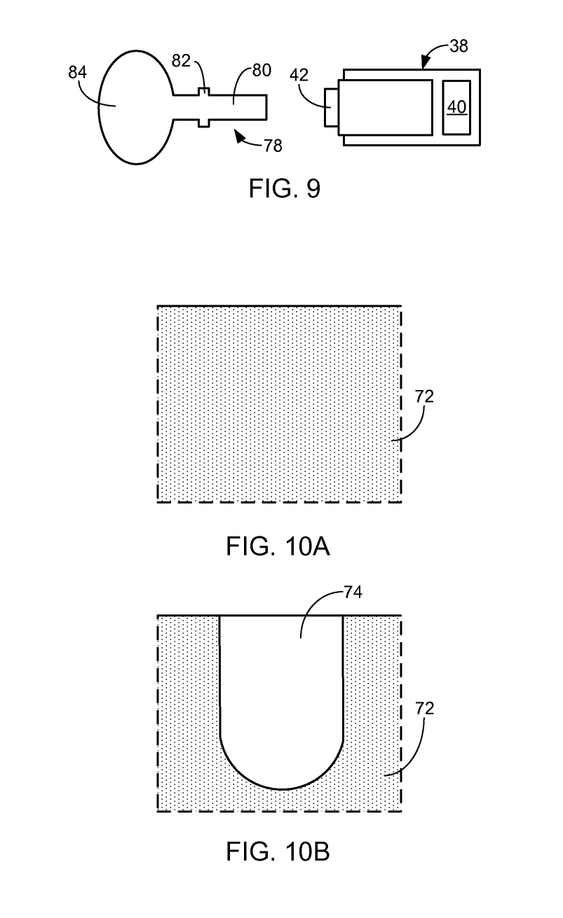

It is important to keep the filler 76 out of the plug receptacle of the identification insert when installing the identification insert into an asset. Since a large portion of the identification insert is usually pushed into the asset, a tool may be used to seal off the plug receptacle while also enabling good handling of the identification insert. For example, FIG. 9 illustrates one embodiment of an insert alignment tool 78 for use when installing an identification insert 38 (having identification circuitry 40) in an asset. The insert alignment tool 78 has a tip 80 sized to be inserted into and removably held by the plug receptacle 42 of the identification insert 38. The insert alignment tool 78 may also have a flange 82 to prevent the tool 78 from being inserted too far into the plug receptacle 42, and for providing a barrier to help prevent filler from getting into the plug receptacle 42. The insert alignment tool 78 may also have a handle 84 to make it easier to position the identification insert 38 attached to the alignment tool 78. In some embodiments, the insert alignment tool 78 may be made from a material to which the filler will not bond so that the alignment tool 78 may be more easily removed after the filler has cured.

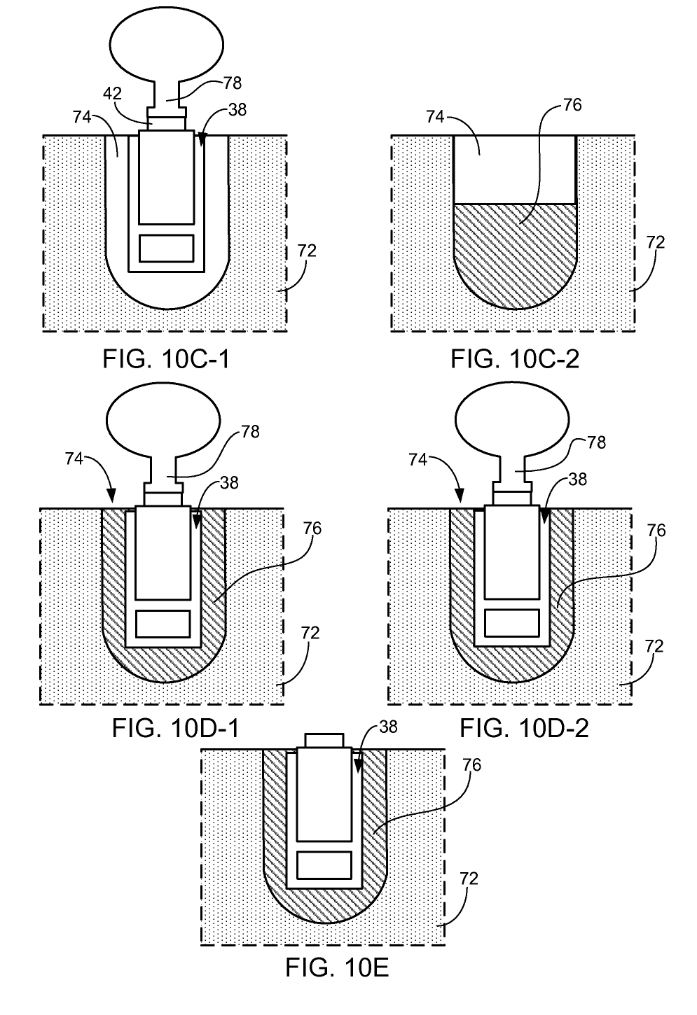

FIGS. 10A-10E illustrate two further embodiments of a method for installing identification circuitry in an asset to make it monitorable by a security asset management system. As in the above methods, FIG. 10A illustrates a portion of an asset 72 into which it is desired to install identification circuitry. Similarly, as illustrated in FIG. 10B, a cavity 74 may be formed in the asset 72. The details of cavity 74 have been discussed in the embodiments above. As illustrated in FIG. 10C-1, an insert alignment tool 78, plugged into an identification insert 38, is used to place a desired portion of the identification insert 38 into the cavity 74 of the asset 72. In this example, it is desired to have all of the identification insert 38, except the tip of the electronic plug receptacle 42 fit within the cavity 74. In the step shown in FIG. 10D-1, the remaining cavity 74 around the identification insert 38 is filled with filler 76, the details of which have been discussed above. When the filler 76 has cured, the insert alignment tool 78 may be removed, as shown in FIG. 10E, and the asset 72 is ready for use with a security asset management system as described above.

In an alternate embodiment, instead of the actions illustrated in FIGS. 10C-1 and 10D-1, the cavity 74 may be at least partially filled with a filler 76 as shown in FIG. 10C-2. The insert alignment tool 78 may then be used to place the identification insert 38 into the cavity 74, before the filler 76 cures, as shown in FIG. 10D-2. Again, when the filler 76 has cured, the insert alignment tool 78 may be removed, as shown in FIG. 10E, and the asset 72 is ready for use with a security asset management system as described above.

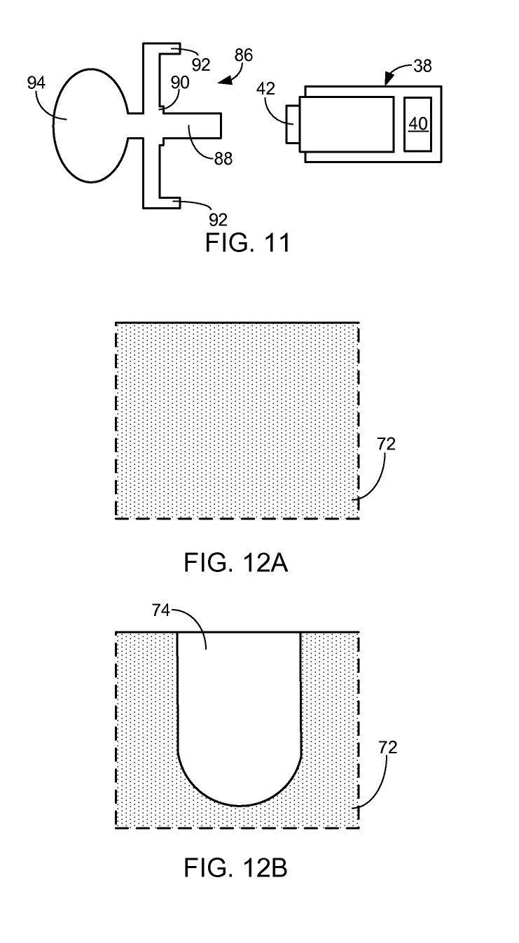

In addition to keeping the filler 76 out of the plug receptacle of the identification insert when installing the identification insert into an asset, it may also be important to control the depth to which the identification insert is inserted into an asset cavity. Another embodiment of a tool may be used to control this insertion depth, while also still sealing off the plug receptacle and enabling good handling of the identification insert. For example, FIG. 11 illustrates another embodiment of an insert alignment tool 86 for use when installing an identification insert 38 (having identification circuitry 40) in an asset. The insert alignment tool 86 has a tip 88 sized to be inserted into and removably held by the plug receptacle 42 of the identification insert 38. The insert alignment tool 86 may also have a flange 90 to prevent the tool 86 from being inserted too far into the plug receptacle 42, and for providing a barrier to help prevent filler from getting into the plug receptacle 42. The insert alignment tool 86 may also have one or more spacers 92 sized to span a cavity in the asset where the identification insert will be placed, and sized to control the depth to which the identification insert is inserted into the cavity. The insert alignment tool 86 may also have a handle 94 to make it easier to position the identification insert 38 attached to the alignment tool 86. In some embodiments, the insert alignment tool 86 may be made from a material to which the filler will not bond so that the alignment tool 86 may be more easily removed after the filler has cured.

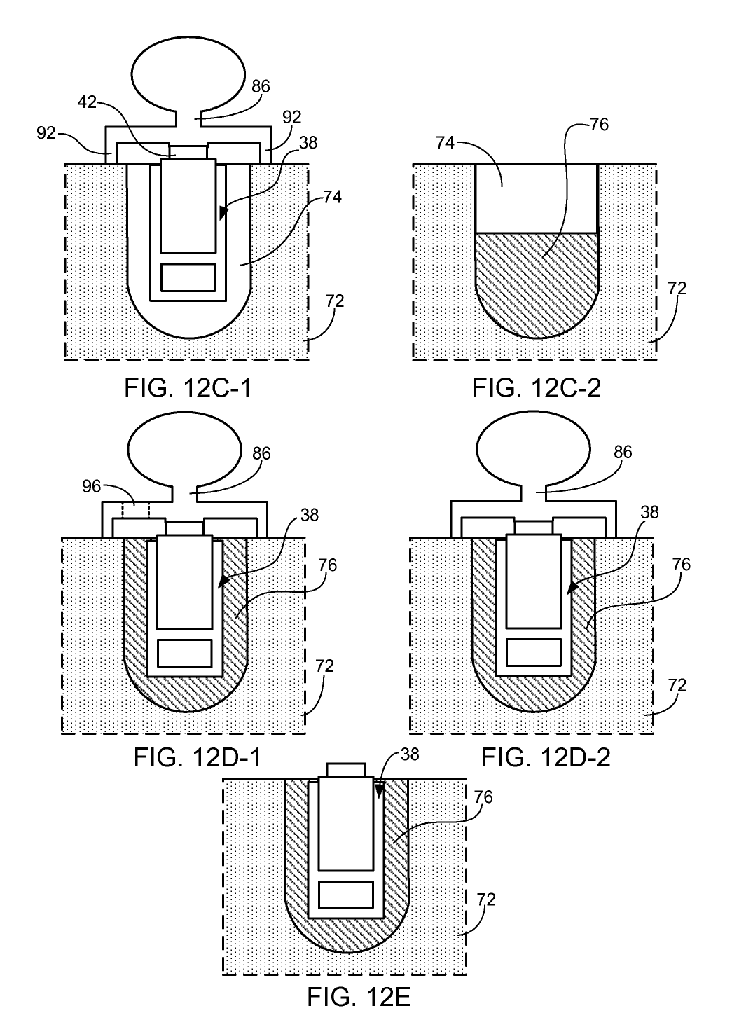

FIGS. 12A-12E illustrate two further embodiments of a method for installing identification circuitry in an asset to make it monitorable by a security asset management system. As in the above methods, FIG. 12A illustrates a portion of an asset 72 into which it is desired to install identification circuitry. Similarly, as illustrated in FIG. 12B, a cavity 74 may be formed in the asset 72. The details of cavity 74 have been discussed in the embodiments above. As illustrated in FIG. 12C-1, an insert alignment tool 86, plugged into an identification insert 38, is used to place a desired portion of the identification insert 38 into the cavity 74 of the asset 72. In this example, it is desired to have all of the identification insert 38, except the tip of the electronic plug receptacle 42 fit within the cavity 74. The spacers 92 of the alignment tool 86 control this insertion depth. In the step shown in FIG. 12D-1, the remaining cavity 74 around the identification insert 38 is filled with filler 76, the details of which have been discussed above. In some embodiments, an optional hole 96 may be defined in the insert alignment tool 86 to provide access for the filler 76 to be filled into the remaining cavity 74 around the identification insert. When the filler 76 has cured, the insert alignment tool 86 may be removed, as shown in FIG. 12E, and the asset 72 is ready for use with a security asset management system as described above.

In an alternate embodiment, instead of the actions illustrated in FIGS. 12C-1 and 12D-1, the cavity 74 may be at least partially filled with a filler 76 as shown in FIG. 12C-2. The insert alignment tool 86 may then be used to place the identification insert 38 into the cavity 74, before the filler 76 cures, as shown in FIG. 12D-2. Again, when the filler 76 has cured, the insert alignment tool 86 may be removed, as shown in FIG. 12E, and the asset 72 is ready for use with a security asset management system as described above.

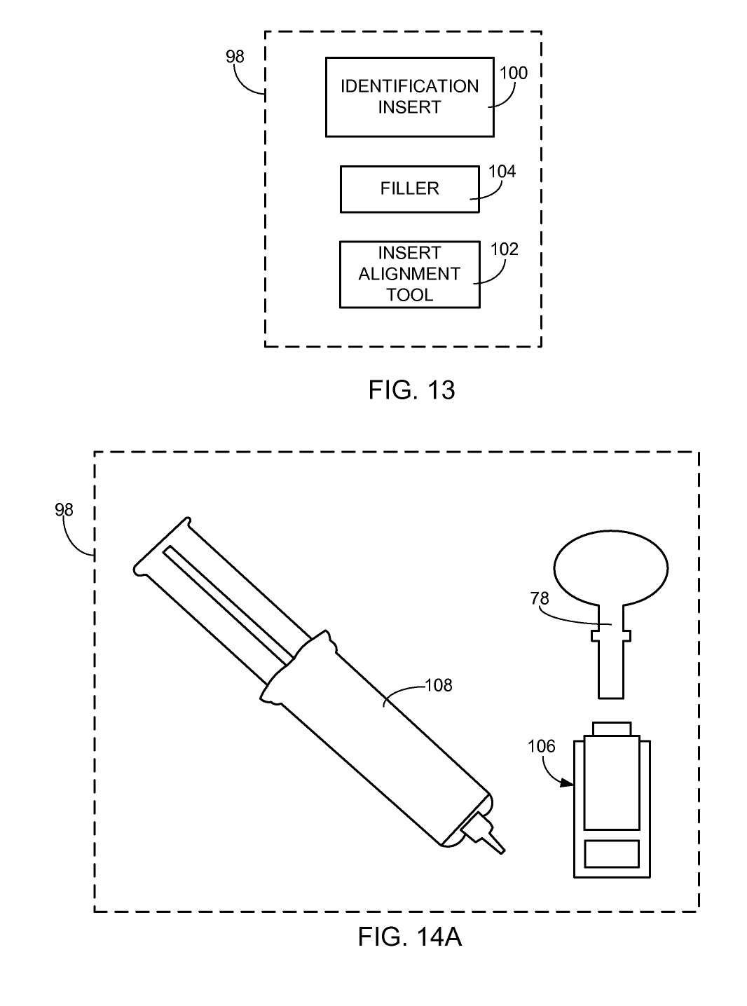

FIG. 13 schematically illustrates an embodiment of a kit 98 for retrofitting an asset to make it monitorable by a security asset management system. The kit 98 includes an identification insert 100 having identification circuitry as discussed in the embodiments and their equivalents above. The kit 98 also includes an insert alignment tool 102 for temporarily coupling to the identification insert 100 during the asset retrofit process as discussed in the embodiments and their equivalents above. The kit 98 further includes a filler 104 as discussed in the embodiments and their equivalents above. Other kit embodiments may include additional items (not shown), such as, but not limited to a) one or more additional insert alignment tools, for example each having spacers for a variety of insertion depths; b) separate spacers to enable a single insert alignment tool to be placed at a variety of corresponding depths; c) a drill bit for forming a cavity in an asset; and d) instructions for retrofitting an asset.

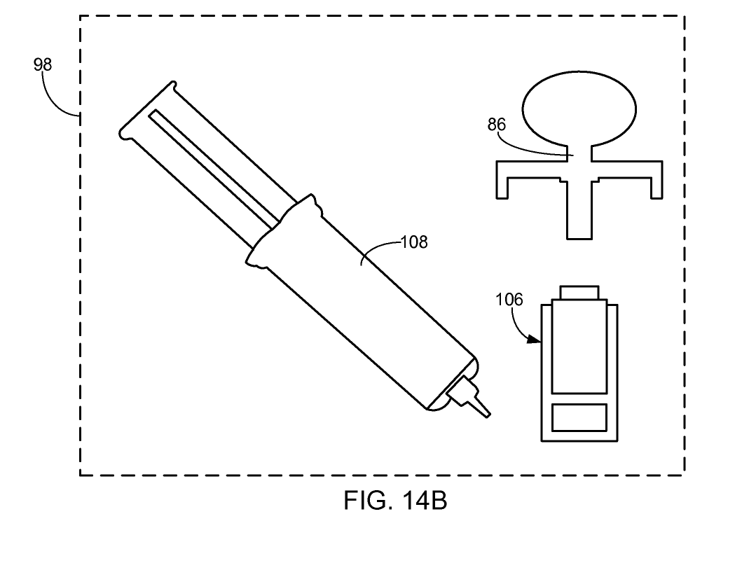

FIG. 14A schematically illustrates another embodiment of a kit 98 for retrofitting an asset to make it monitorable by a security asset management system. The kit 98 includes an identification insert 106 having a touch memory chip compatible for use with the Dallas Semiconductor 1-wire bus as discussed above. The kit 98 also includes an insert alignment tool 78, the details of which have been discussed above. The kit 98 also includes a filler 108 that is an epoxy.

FIG. 14B schematically illustrates a further embodiment of a kit 98 for retrofitting an asset to make it monitorable by a security asset management system. The kit 98 includes an identification insert 106 having a touch memory chip compatible for use with the Dallas Semiconductor 1-wire bus as discussed above. The kit 98 also includes an insert alignment tool 86, the details of which have been discussed above. The kit 98 further includes a filler 108 that is an epoxy.

Having thus described several embodiments of the claimed invention, it will be rather apparent to those skilled in the art that the foregoing detailed disclosure is intended to be presented by way of example only, and is not limiting. Many advantages for the method, system, and kit for making an asset monitorable by a security asset management system have been discussed. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. An identification insert, comprising:
a support layer;
a plug receptacle mounted on the support layer, the plug receptacle including at least two electrical contacts; and
identification circuitry mounted on the support layer and electrically coupled to the at least two electrical contacts of the plug receptacle, wherein
the plug receptacle places a plug in electrical communication with the identification circuitry when the plug is inserted into the plug receptacle.

2. The identification insert of claim 1, wherein the identification circuitry comprises at least a portion of a touch memory device.

3. The identification insert of claim 1, wherein the support layer comprises a circuit board including respective conductors that places the at least two contacts in electrical communication with the identification circuitry.

4. The identification insert of claim 1, wherein the support layer is mounted in a cavity in an asset to be monitored such that the plug receptacle is accessible from outside of the asset to be monitored.

5. The identification insert of claim 4, wherein the asset is a firearm and the cavity is formed in a portion of the firearm.

6. The identification insert of claim 4, further comprising a housing formed to correspond to the cavity such that an external surface of the housing is substantially flush with an external surface of the asset to be monitored.

7. The identification insert of claim 1, further comprising a filler substantially covering all but the plug receptacle of the insert.

8. A security asset management system, comprising:
an identification insert including:
a plug receptacle;
identification circuitry electrically coupled to the plug receptacle; and
a support layer coupled to and configured to support the plug receptacle and the identification circuitry;
a cable including a plug corresponding to the plug receptacle; and
a controller coupled to the cable and in communication with the identification circuitry via the cable and the plug receptacle when the plug is plugged into the plug receptacle of the identification insert, and wherein the controller includes a computing device in communication with a non-transitory storage medium having computer-readable instructions stored thereon in the form of executable code that when executed by the computing device causes the controller to determine the presence and removal of an asset coupled to the identification insert based on communication with the identification circuitry.

9. The identification insert of claim 8, wherein the support layer comprises a circuit board including respective conductors that places the at least two contacts in electrical communication with the identification circuitry.

10. The identification insert of claim 8, wherein the support layer is mounted in a cavity in an asset to be monitored such that the plug receptacle is accessible from outside of the asset to be monitored.

11. The identification insert of claim 10, wherein the asset is a firearm and the cavity is formed in a portion of the firearm.

12. The identification insert of claim 10, further comprising a housing formed to correspond to the cavity such that an external surface of the housing is substantially flush with an external surface of the asset to be monitored.

13. The identification insert of claim 8, further comprising a filler substantially covering all but the plug receptacle of the insert.

14. A method of making an asset monitorable by a security asset management system, comprising:
obtaining an identification insert including identification circuitry electrically coupled to the plug receptacle, and a support layer coupled to and configured to support the plug receptacle and the identification circuitry
placing the identification insert at least partially into a cavity defined in the asset; and
filling at least a portion of the cavity with a filler, thereby surrounding substantially all of the identification insert, leaving the plug receptacle accessible from outside the asset.

15. The method of claim 14, wherein placing the identification insert at least partially into the cavity defined in the asset comprises using an insert alignment tool to place the identification insert at least partially into the cavity, the insert alignment tool covering the plug receptacle to deter filler from entering the plug receptacle.

16. The method of claim 15, further comprising using the insert alignment tool to control an insertion depth of the identification insert into the cavity.

17. The method of claim 16, further comprising using a tip of the insert alignment tool sized to be inserted into and removably held by the plug receptacle, the using of the insert alignment tool to control an insertion depth includes using a flange of the insert alignment tool connected to the tip and sized to define a maximum insertion depth of the tip into the plug receptacle, and using a handle of the insert alignment tool connected to the flange.

18. The method of claim 17, wherein the insert alignment tool further includes at least one spacer sized to span the cavity.

19. The insert alignment tool of claim 15, further comprising using a hole in the insert alignment tool to fill the at least a portion of the cavity with the filler.

20. The method of claim 15, further comprising obtaining a kit for retrofitting an asset, the kit including the identification insert, the insert alignment tool, and the filler.
